(19) United States
(12) Patent Application Publication
(10) Pub. No.: US 2008/0250240 A1
(43) Pub. Date: Oct. 9, 2008

(54) Remote Informed Watermark Detection System

(75) Inventors: Mehmet Utku Celik, Eindhoven (NL); Minne Van Der Veen, Eindhoven (NL); Aweke Negash Lemma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,755

(22) PCT Filed: Oct. 6, 2006
(86) PCT No.: PCT/IB06/53663

§ 371 Date: Apr. 10, 2008

(30) Foreign Application Priority Data
Oct. 13, 2005 (EP) 05109515.6

(51) Int. Cl. H04L 9/00

(52) U.S. Cl. 713/155

(57) ABSTRACT

A system and a method for secure remote informed watermark detection making use of a side-information. The system in overview comprises a remote detector and a server computing system wherein a database with side-information assigned to specific descriptors of data signals is stored at the server computing system and wherein a remote detector intending to identify the watermark of a data signal will derive the descriptor of the data signal and subsequently contact the trusted server computing system in order to obtain the necessary side-information for the informed watermark detection.

### FIELD OF THE INVENTION

The present invention relates to remote informed watermark detection system, in particular the invention relates to a remote informed watermark detection system wherein the side-information used at the informed detector is transmitted in response to a request at the server computing system. The invention further relates to a method for remote informed watermark detection, moreover the invention relates to software for implementing the method.

### BACKGROUND OF THE INVENTION

Digital watermarking has proven an effective deterrent against illegal distribution of copyrighted material in digital form, for instance over computer networks, via electronic content distribution (ECD) applications or via hand-to-hand public distribution.

Watermarking is implemented generally by a pre-coding stage where a watermark is generated and a transcoding watermark embedding stage where the watermark is added to the original data signal in a single or a series of locations within the data signal. Subsequently a watermark detector may extract the watermark from the watermarked data signal in a copyright identification process.

A blind detector extracts the watermark based only in the watermarked data signal. An informed detector is a watermark detector that has access to the original data signal or to some information derived form the original data signal, generally named side-information. An informed detector generally utilizes the side-information to perform re-synchronization and/or eliminate host-signal interference.

Secure informed detection in a network can be implemented by means of centralized server as a large side-information database may be kept at the server. In order to reduce the load of the centralized server and optimise the watermark detection process it would be desirable to perform the informed detection at the clients of the network following a peer-to-peer network model. On the other hand the client/peer devices are in a potentially hostile environment and cannot be fully trusted with the handling of the side-information.

A system that allows performing informed watermark detection for digital video signals at a client has been described in the published US-application 2004/0234099. The system utilizes side-information based on hash values of a series of selected frames in order to help in the synchronization at the detector by indicating which frames are to be used in the watermark detection.

The inventor of the present invention has appreciated that an improved remote informed watermark system is of benefit, and has in consequence devised the present invention.

### SUMMARY OF THE INVENTION

The present invention seeks to provide an improved system that enables secure and trusted transfer of the side-information between the centralized server and the client performing the informed watermark detection independently of the type of data signal watermarked. Preferably, the invention alleviates, mitigates or eliminates one or more of the above or other disadvantages singly or in any combination.

Accordingly there is provided, in a first aspect, a remote detector and a server computing system;

wherein the remote detector is operable to
receive a data signal;
request side-information at the server computing system;
receive the side-information from the server computing system in response to requesting the side-information;
extract, based on the data signal and the received side-information, information relating to a watermark possibly present in the data signal;

The watermark detection system is a remote informed watermark detection system. For such systems may the detection of the watermark depend on the architecture in question, for example may the detection be performed at the central server, at distributed servers, at a client or a pier. The remote detector is typically a computing system running a software implementation operable to determine, based on the data signal and the received side-information, whether or not a watermark is present in the data signal. The remote detector may e.g. be a web-spider looking for forensic watermarks. The side-information, or at least instructions to generate the side-information is located at a database which can be located at the server computing system. The database can also be located at other computer systems connected to the server computing system. The data signal consists in an amount of organized digital data being temporarily or permanently stored in, and/or accessed from, a hard disk, diskette, DVD, CD-ROM, USB-Key or any other similar read-only or read-and-write memory elements. Extracting information relating to a watermark present in the data signal typically consists of a first step where the side-information is used to adapt the data signal in a way that simplifies a second step where the actual information relating to a watermark is obtained. Extracting information relating to a watermark also includes extracting the information that no watermark is present or that a zero bit watermark is present.

The invention is particularly by not exclusively advantageous for a number of reasons. An important advantage is that the invention enables informed detection in remote detectors without large storage resources. For instance, the remote detector may be one of the servers in a distributed environment or a client/peer machine in a peer-to-peer setting. However, since the remote detector is communicatively connected to a server computing system, the remote detector may profit from the computing power of the server computing system, this may be utilized to improve the such features as the detection speed and the accuracy of the of watermark detection, as compared to remote detectors not being communicatively connected to a server computing system. Moreover, since the remote detector need not be a powerful computing system, the cost of the remote detector may be reduced. On the other hand, also the computing power of the remote detector may beneficially be used for load distribution from the server computing system to the computing system of the remote detector.

The optional features as defined in claims 2 and 3 are advantageous since the server computing system will provide specific side-information related to a descriptor derived from the data signal. The descriptor is typically information that can identify the data signal; it may e.g. be meta-data from the data signal or a fingerprint computed from the data signal.

The optional features as defined in claim 4 are advantageous since it allows to determine based on the data signal and the received side-information, whether a watermark is present in the data signal.

The optional features as defined in claim 5 are advantageous since the watermark detection step includes decoding a payload encoded in the watermark.

The optional features as defined in claims 6 and 7 are advantageous since by providing synchronization information as the side-information the remote detector is allowed to identify positions of the data signal wherein the watermark may be found. A fast synchronization of the data signal at the watermark detector reduces the complexity of the watermark detection process, thereby increasing its efficiency.

The optional features as defined in claims 8 and 9 are advantageous since by assigning a degree of trust to the remote detector, and by selecting the side-information based on the degree of trust, the content of the side-information may be selected in accordance with the trust, so that if the remote detector is not a trusted device, the side-information may not disclose sufficient information to reconstruct the original signal. The degree of trust may advantageously be established by the remote detector by providing credentials to the server.

The optional features as defined in claim 10 are advantageous since host-signal interference may be a problem in some applications. In general, host-signal interference may be reduced or removed by subtracting the host signal rom the received signal. The use of side-information in a watermark detection, e.g. in correlation-based watermark detection, may improve significantly the performance.

The optional features as defined in claim 11 are advantageous since by including at least a part of the data signal in the side-information, e.g. host-signal interference may be dealt with in an effective way.

The optional features as defined in claims 12 to 15 disclose advantageous embodiments according to the type of data signal obtained at the remote detector. In claim 8 wherein the data signal is an image, the side-information allows for the image to be resized to its original dimensions inducing simplicity in the watermark detector. In claim 9 wherein the data signal is an audio sequence, the side-information may provide the location within the audio sequence wherein the watermark can be found, reducing the time required for the watermark detection process. In claim 10 wherein the data signal is a video sequence, the side-information allows for resizing and/or rearranging and/or re-sampling the images within the video sequence in a way that simplifies the watermark detection process.

The optional features as defined in claims 16 and 17 disclose advantageous alternative embodiments where the side-information is directly accessible at the server computing system, e.g. in a database, or at least partly generated upon arrival of a request.

In a second aspect is provided a remote detector for watermark detection in accordance with the first aspect of the invention, and in a third aspect is provided a server computing system for watermark detection in accordance with the first aspect of the invention.

In a fourth aspect of the invention is provide method for detecting the presence of a watermark in a data signal, the method comprising the steps of providing the data signal to a remote detector;

requesting by the remote detector side-information at a server computing system receiving at the remote detector the side-information from the server computing system in response to requesting the side-information
extracting at the remote detector, based on the data signal and the received side-information, information relating to a watermark possibly present in the data signal

The method may be implemented for controlling a remote detector and/or a server computing system of the first, second and/or third aspect of the invention.

In a fifth aspect of the invention is provided computer readable code for implementing the method of the fourth aspect.

In general the various aspects of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

The present invention will be now explained, by the way of example only, with reference to the accompanying Figures wherein:

FIG. 1 is a schematic diagram illustrating a general remote informed watermark detection system;

FIG. 2 is a detailed diagram illustrating the elements of a remote informed watermark detection system and the signals exchanged within the process according to a first embodiment of the invention;

FIG. 3 is a flow chart illustrating steps executed at a remote detector of a method of remote informed watermark detection according to a second embodiment of the invention;

FIG. 4 is a flow chart illustrating steps executed at a server computing system of a method of remote informed watermark detection according to a second embodiment of the invention; and

FIG. 5 is a schematic diagram illustrating the elements of a remote informed watermark detection system and the signals exchanged within according to a third embodiment of the invention wherein the descriptor is a fingerprint and the informed detector performs a resynchronisation previous to the watermark detection.

### DESCRIPTION OF EMBODIMENTS OF THE INVENTION

It is a requirement of an informed watermark detector to have access to the side-information which will be used in the detection process. A remote watermark detector is in general an untrusted entity and side-information should only be provided to the remote detector a controlled and secure channel.

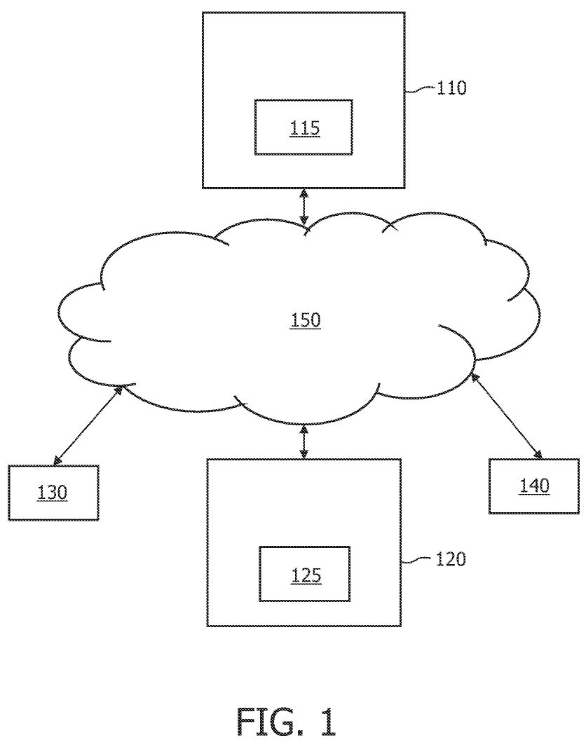

An illustrative representation of the typical architecture of a remote informed watermark detector system is shown in FIG. 1. It consists of a server computing system 110, a series of clients 120, 130, 140 and a computer network 150 that allows communication between the server computing system 110 and the clients 120, 130, 140, e.g. the Internet. The server computing system comprises among other components a side-information database 115. A client 120 intending to perform a remote informed watermark detection comprises among other components a remote detector 125. The server computing system and the clients can comprise other elements or components, e.g. processors, memories, a user interface, etc.

Whenever the client 120 wants to obtain the watermark of a data signal, obtained for example from the Internet, the remote detector 125 of the client will contact the server computing system 110 in order to obtain a necessary side-information to be used in the informed watermark detection. If the client 120 is a trusted entity the server computing system will send to the client the side-information and the remote detector 125 will proceed with the watermark extraction process.

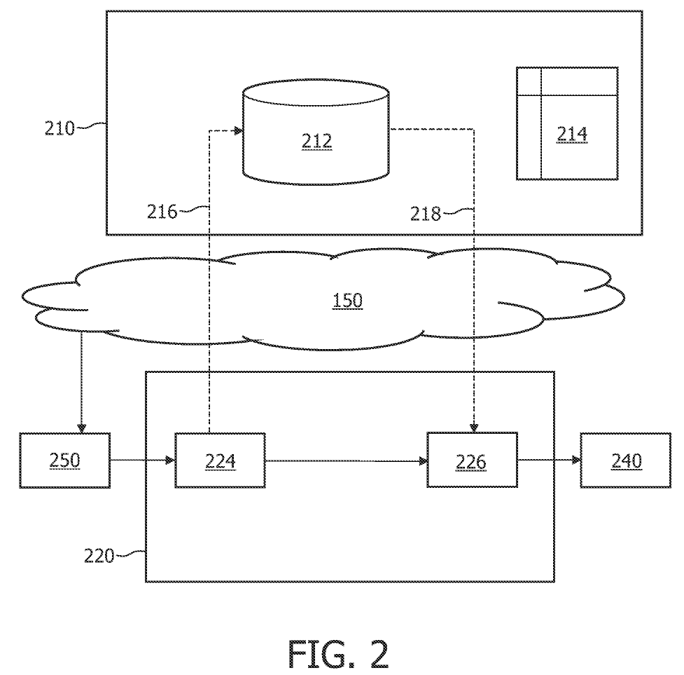

A more detailed diagram, including elements of a remote informed watermark detection system and signals exchanged within the process according to a first embodiment of the invention is shown in FIG. 2. It consists of a server computing system 210, a remote detector 220 and a computer network 150. The remote detector 220 comprises of a descriptor deriver 224 and an informed watermark detector 226. The server computing system 210 comprises of a side-information database 212 wherein information is typically represented by a look up table 214. The remote detector typically will obtain a data signal 250 from the Internet and derive a descriptor 216 from the data signal at the descriptor deriver 224. The descriptor 216 is sent to the server computing system 210 which checks the look up table 214 for an entrance with the descriptor 216, extracts the corresponding side-information 218 assigned to the specific descriptor, and sends the side-information back to the informed watermarked detector 226. The informed watermarked detector 226 will use the side-information 218 in the watermark detection process in order to extract a watermark 240 or information related to a watermark.

In one embodiment of the invention the descriptor may not be necessary in order to obtain the side-information from the server computing system, in this embodiment a specific request from the remote detector will be used in order to obtain the required side-information.

In another embodiment of the invention the side-information database is partially placed at the server computing system. The side-information database may be implemented as a distributed database with data placed in multiple servers allowing load balancing of the side-information database. In this case a request at the server computing system from the remote detector is shared with the other servers members of the distributed database while the control of the secure communication channel is still a task assigned to the server computing system.

In another embodiment of the invention the server computing system may reply to a single request for side-information with a multiple of side-information entities. For example if the data signal is a movie, which can be considered divided into a multitude of parts, and the remote detector requests side-information for the first part of the movie, the server computing system may reply by sending side-information for several parts of the movie or for all of the parts of the movie.

In another embodiment of the invention different side-information is assigned to a unique descriptor according to the level of trust assigned to the remote detector contacting the server computing system. For example the complete data signal could be the side-information provided by the server computing system to a fully trusted remote detector. On the other hand the side-information may be relatively scarce, e.g. original size of the image for a picture, in the case wherein the remote detector is considered of high risk and untrusted.

In another embodiment of the invention the remote detector may keep a small database of side-information for most recent or most detected data signals if some data signals are tested for watermarks repeatedly. The side-information stored in the database might have a time stamp indicating a limited access in time for the side-information according to the expected time the particular remote detector continues to be within the same trusted category. This embodiment will achieve a reduced workload of the server computer system without jeopardizing the secure channel.

In yet another possible embodiment of the invention the side-information is generated at the server computing system in response to the descriptor provided by the remote detector, as it is not available in forehand at a side-information database.

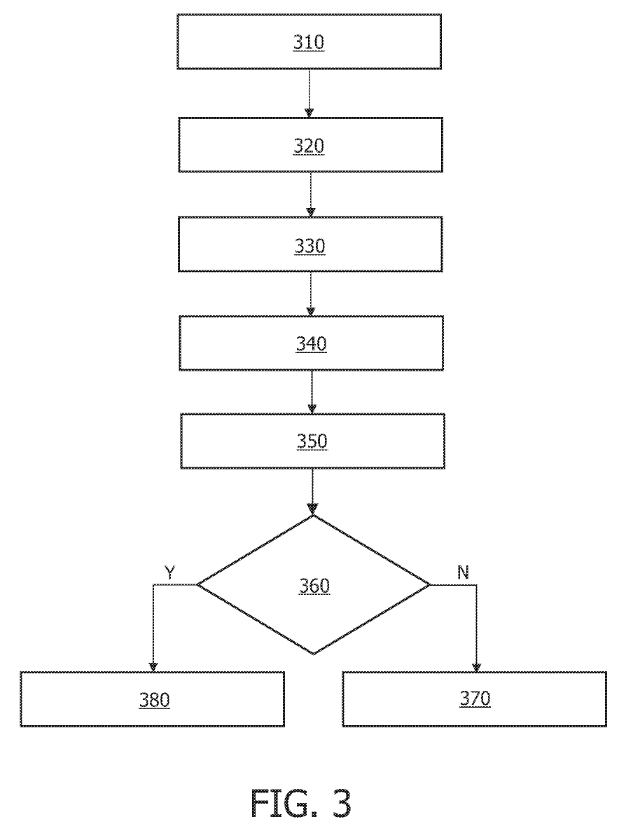

A flow chart illustrating steps executed at a remote detector 220 for a method of remote informed watermark detection according to a second embodiment of the invention is presented in FIG. 3. In step 310 the remote detector 220 obtains a data signal, e.g. receives it from the Internet within use of a web-spider looking for forensic watermarks, In step 320 a descriptor is derived from the data signal and is subsequently transmitted 330 to a server computing system 210. In step 340 the remote detector 220 receives, in response to the descriptor, a message from the server computing system and subsequently transmits an acknowledgement message 350 to the server computing system indicating the correct reception of the message. In step 360 the remote detector checks if the message contains side-information. If the message contains other than side-information, e.g. the message indicates that the side-information was not found at the server computing system, the remote detector will stop communication with the server computer system 370. If the message contains recognized side-information the informed watermark detection unit will extract the watermark based on the data signal and the received side-information 380.

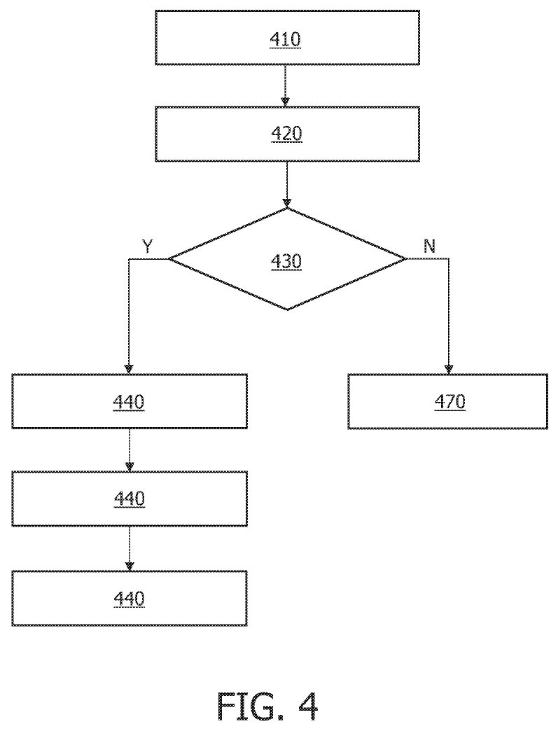

A flow chart illustrating steps executed at a server computing system of a method of remote informed watermark detection according to a second embodiment of the invention are presented in FIG. 4. In step 410 a descriptor is received at the server computing system from the remote detector. The server computing system uses the descriptor as the input to a look up table 214 of a side-information database 212 to obtain the assigned side-information to the received descriptor. If the descriptor is not found in the look up table and therefore in the database, the server computing system will send 470 a specific message to remote detector indicating that the descriptor was not found and may subsequently stop communications with the remote detector. If the descriptor is found in the look up table 212, the side-information is extracted 440 from the side-information database 214 and subsequently transmitted 450 to the remote detector. The server computing system will wait 460 for an acknowledgement message from the remote detector before finalizing the specific process of the actual descriptor.

Communications between the server computing system and remote detector can occur via the same or different communication connections within the computer network, i.e. the descriptor is send from the remote detector to the server computing system through a different path than the side-information is send from the server computing system to the remote detector.

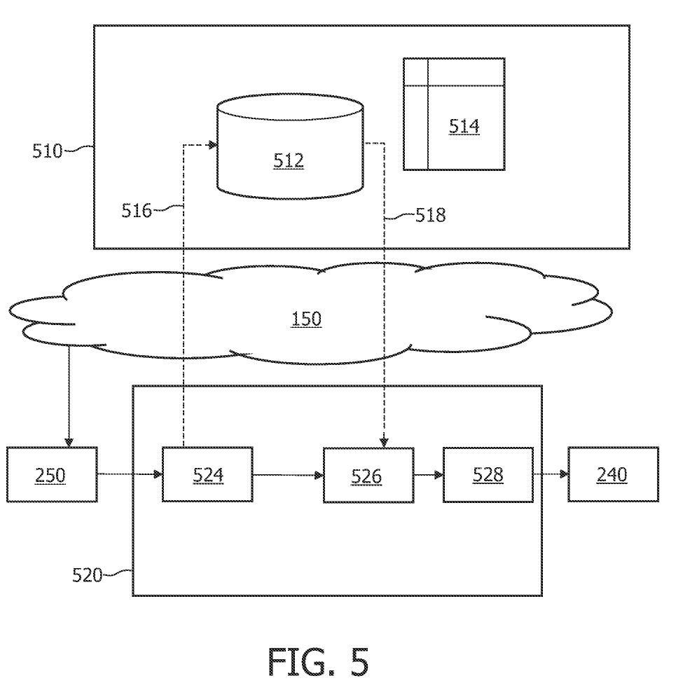

The elements of a remote informed watermark detection system and the signals exchanged within for a specific embodiment of the invention are illustrated in FIG. 5. In this embodiment of the invention the descriptor used is a fingerprint and the informed detector performs a resynchronisation previous to the watermark detection. The system consists of a server computing system 510, a remote detector 520 and a computer network 150. The remote detector 520 comprises a fingerprint deriver 224, a re-synchronizer 526 and a watermark detector 528. The server computing system 510 comprises of a synchronization information database 512 wherein information is typically represented by a look up table 514. The remote detector typically will obtain a data signal 250 from the Internet and derive a fingerprint 516 from the data signal at the fingerprint deriver 524. The fingerprint can for example be a key identifier based on a specific repeatable calculation involving the data signal that identifies it uniquely. The fingerprint 516 is sent to the server computing system 510 which checks the look up table 514 for an entrance with the fingerprint 516, extracts the corresponding synchronization information 518 assigned to the specific fingerprint, and sends the synchronization information back to the re-synchronizer 526. The synchronization information is used to prepare the data signal for the watermark detection process 528 by performing a re-synchronization step 526. The synchronization information 518 will have different content according to the actual content of the data signal, for example in a data signal containing an audio sequence the synchronization information could consist of specific time-stamps within the audio sequence where the re-synchronization process 526 will provide to the watermark detector 528 only the segments of the audio sequence wherein watermark 540 is expected to be present, reducing the complexity of the watermark detection process and improving its performance.

The invention can be implemented in any suitable form including hardware, software, firmware or any combination of these. The invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. A watermark detection system, comprising:
a remote detector; and
a server computing system for receiving a data signal and receiving side-information in response to a request for the side-information wherein the server computing system extracts information relating to a watermark possibly present in the data signal, based on the data signal and the received side-information.

2. The system according to claim 1, wherein the request for side-information comprises deriving
a descriptor from the data signal
and transmitting the descriptor to the server computing system.

3. The system according to claim 2, wherein the server computing system is operable to
receive a descriptor from the remote detector;
in response to receiving the descriptor, obtain a side-information; and
transmit the side-information to the remote detector.

4. (canceled)

5. The system according to claim 1, further comprising decoding a payload encoded in the watermark.

6. The system according to claim 1, wherein the side-information comprises synchronization information that allows for re-synchronization in the watermark detection system.

7. The system according to claim 6, wherein the synchronization information includes locations of salient points in the signal.

8. The system according to claim 1, wherein a degree of trust is assigned to the remote detector, and the side-information is selected based on the degree of trust.

9. The system according to claim 8, wherein the degree of trust is established by the remote detector by providing credentials to the server.

10. The system according to claim 1, wherein the side-information comprises information that allows for elimination of a host-signal interference.

11. The system, according to claim 1, wherein the side-information comprises at least a part of the data signal.

12. The system according to claim 1, wherein the data signal comprises at least one of an image, a video sequence and an audio sequence.

13. The system according to claim 12, wherein the data signal is an image and the side-information provides information that allows the image to be resized to its original dimensions.

14. The system according to claim 12, wherein the data signal is an audio sequence comprising a series of audio segments and the side-information comprises a fingerprint and/or a time-stamp corresponding to at least one of the audio segments.

15. (canceled)

16. The system according to claim 1, wherein the side-information is stored at the server computing system prior to receiving the descriptor.

17. The system according to claim 1, wherein the side-information is generated at the server computing system in response to receiving the descriptor.

18. A remote detector for watermark detection being operable to
receive a data signal;
request side-information at the server computing system;
receive the side-information from the server computing system in response to requesting the side-information; and
extract, based on the data signal and the received side-information, information relating to a watermark possibly present in the data signal;

19. (canceled)

20. (canceled)

21. Computer readable code for implementing the method of claim 1.
